(19) United States
(12) Patent Application Publication
(10) Pub. No.: US 2026/0045530 A1
(43) Pub. Date: Feb. 12, 2026

(54) STRIP TERMINAL ALIGNMENT DEVICE AND METHOD OF MANUFACTURING RECHARGEABLE BATTERY USING THE SAME

(71) Applicant: Samsung SDI Co., Ltd., Yongin-si (KR)

(72) Inventors: Junho Byeon, Yongin-si (KR); Byunghuy Cho, Yongin-si (KR); Hyojin Lim, Yongin-si (KR); Soyun Kim, Yongin-si (KR)

(73) Assignee: Samsung SDI Co., Ltd., Yongin-si (KR)

(21) Appl. No.: 19/197,805

(22) Filed: May 2, 2025

(30) Foreign Application Priority Data
Aug. 6, 2024 (KR) 10-2024-0104888

(51) Int. Cl. H01M 10/04; H01M 50/528; H01M 50/557; H01M 50/564

(52) U.S. Cl. CPC H01M 10/0404; H01M 10/049; H01M 50/528; H01M 50/564; H01M 50/557

(57) ABSTRACT

A strip terminal alignment device according to some embodiments includes: a terminal support supporting first and second strip terminals; first and second jigs configured to be reciprocally moved along a first direction and disposed at a distance from the terminal support along a second direction; a pair of first pushers fixed to the first jig; and a pair of second pushers fixed to the second jig. The pair of first pushers pushes one side of each of the first and second strip terminals in one direction, and the pair of second pushers pushes the other side of each of the first and second strip terminals in the other direction according to the movement of the first and second jigs. Each of the pair of first pushers and the pair of second pushers includes a vertical extension parallel to a third direction orthogonal to the first direction and the second direction.

### CROSS-REFERENCE TO RELATED APPLICATIONS

This present application claims priority to and the benefit under 35 U.S. C. § 119(a)-(d) of Korean Patent Application No. 10-2024-0104888, filed on Aug. 6, 2024, in the Korean Intellectual Property Office, the entire disclosure of which is incorporated herein by reference.

### FIELD

The present disclosure relates to a strip terminal alignment device.

### BACKGROUND

Rechargeable batteries are used for various purposes, such as a power source for small electronic devices such as mobile phones and laptop computers, and a power source for driving motors for transportation vehicles such as electric vehicles and hybrid vehicles. In the former case, pouch-type rechargeable batteries are mainly used for slimming small electronic devices.

### SUMMARY

According to some embodiments, the present disclosure provides a strip terminal alignment device that may properly align strip terminals at a designated position during the process of assembling an electrode assembly to which the strip terminals are coupled and a pouch-shaped case. In addition, some embodiments of the present disclosure provides a method of manufacturing a rechargeable battery using the strip terminal alignment device.

Some embodiments provide a strip terminal alignment device, including: a terminal support, first and second jigs, a pair of first pushers, and a pair of second pushers. The terminal support may support first and second strip terminals. The first and second jigs may be configured to be able to be reciprocally moved along a first direction, and may be disposed at a distance from the terminal support along a second direction. The pair of first pushers may be fixed to the first jig at a distance from each other, and push one side of each of the first and second strip terminals in one direction according to the movement of the first jig. The pair of second pushers may be fixed to the second jig at a distance from each other, and push the other side of each of the first and second strip terminals in the other direction (e.g., a direction opposite the one direction) according to the movement of the second jig. Each of the pair of first pushers and the pair of second pushers may include a vertical extension parallel to a third direction orthogonal to the first direction and the second direction.

Each of the first and second jigs may be disposed higher than the terminal support along the third direction. The second jig may be disposed between the terminal support and the first jig along the second direction.

Each of the pair of first pushers may include a first fixing portion fixed to the first jig, a first horizontal extension connected to the first fixing portion and parallel to the second direction, and a first vertical extension connected to the first horizontal extension and parallel to the third direction. An end portion of the first vertical extension may face one side of each of the first and second strip terminals.

The first horizontal extension may cross an upper portion of the second jig at a distance from the upper surface of the second jig. Each of the first and second strip terminals may include an inner portion fixed to an electrode assembly, a middle portion surrounded by an insulating film, and an outer portion exposed to the outside (an outside area) of the case. A width of the first vertical extension along the second direction may be smaller than a length of the outer portion along the second direction.

A width of the first vertical extension along the second direction may be equal to or less than half a length of the outer portion along the second direction. An end portion of the first vertical extension may be disposed at a distance from the insulating film along the second direction. A distance between an end portion of the first vertical extension and the insulating film may be 0.3 times or more and 0.7 times or less of a length of the outer portion along the second direction.

Each of the pair of second pushers may include a second fixing portion fixed to the second jig, a second horizontal extension connected to the second fixing portion and parallel to the second direction, and a second vertical extension connected to the second horizontal extension and parallel to the third direction. An end portion of the second vertical extension may face the other side of each of the first and second strip terminals.

A width of the second vertical extension along the second direction may be smaller than a length of the outer portion along the second direction. A width of the second vertical extension along the second direction may be equal to or less than half a length of the outer portion along the second direction. An end portion of the second vertical extension may be disposed at a distance from the insulating film along the second direction. A distance between an end portion of the second vertical extension and the insulating film may be 0.3 times or more and 0.7 times or less of a length of the outer portion along the second direction.

The pair of first pushers and the pair of second pushers may move in opposite directions to contact side surfaces of the first and second strip terminals, respectively, to align the first and second strip terminals at a reference position, respectively.

Other embodiments provide a method of manufacturing a rechargeable battery, which may include: fixing first and second strip terminals to an electrode assembly; accommodating the electrode assembly in a first case and disposing the first and second strip terminals on a terminal support; disposing a pair of first pushers on one side of each of the first and second strip terminals and disposing a pair of second pushers on the other side of each of the first and second strip terminals; moving the pair of first pushers and the pair of second pushers in opposite directions to respectively align the first and second strip terminals to a reference position; and disposing a second case on the electrode assembly and sealing edges of the first case and the second case. Each of the pair of first pushers and the pair of second pushers may include a vertical extension parallel to a thickness direction of the first and second strip terminals, and may be in contact with a portion of a side surface of each of the first and second strip terminals at an end portion of the vertical extension.

Each of the first and second strip terminals may include an inner portion fixed to the electrode assembly, a middle portion surrounded by an insulating film, and an outer portion disposed on the terminal support. After sealing the first and second cases, the insulating film may overlap sealing portions of the first and second cases.

Each of the pair of first pushers may include a first vertical extension. A width of the first vertical extension along a length direction of the first and second strip terminals may be smaller than a length of the outer portion. An end portion of the first vertical extension may be disposed at a distance from the insulating film. A width of the first vertical extension may be less than half a length of the outer portion. A distance between the insulating film and the first vertical extension may be 0.3 times or more and 0.7 times or less of a length of the outer portion.

Each of the pair of second pushers may include a second vertical extension. A width of the second vertical extension along a length direction of the first and second strip terminals may be smaller than a length of the outer portion. An end portion of the second vertical extension may be disposed at a distance from the insulating film. A width of the second vertical extension may be less than half a length of the outer portion. A distance between the insulating film and the second vertical extension may be 0.3 times or more and 0.7 times or less of a length of the outer portion.

The strip terminal alignment device of the present embodiments may minimize the thermal influence on the insulating film during the process of aligning the first and second strip terminals using a pair of first pushers and a pair of second pushers. As a result, the shape deformation and functional deterioration of the insulating film may be suppressed, and the safety of the rechargeable battery may be improved.

### BRIEF DESCRIPTION OF THE DRAWINGS

FIG. 1 illustrates an exploded perspective view of a typical pouch-type rechargeable battery.

FIG. 2 illustrates a partially enlarged view of a typical pouch-type rechargeable battery.

FIG. 3 illustrates a plan view of a strip terminal alignment device according to some embodiments.

FIG. 4 illustrates a cross-sectional view of the strip terminal alignment device taken along line IV-IV of FIG. 3.

FIG. 5 illustrates a cross-sectional view of the strip terminal alignment device taken along line V-V of FIG. 3.

FIG. 6 is a plan view of a strip terminal alignment device for describing an operation of the strip terminal alignment device according to some embodiments.

FIG. 7 is a plan view of a strip terminal alignment device for describing an operation of the strip terminal alignment device according to some embodiments.

FIG. 8 illustrates a process flowchart of a method of manufacturing a rechargeable battery according to some embodiments.

FIG. 9 illustrates a perspective view of an electrode assembly and first and second strip terminals corresponding to act S10 shown in FIG. 8.

FIG. 10 illustrates a partially enlarged cross-sectional view of the electrode assembly shown in FIG. 9.

FIG. 11 illustrates a perspective view of a modified example of the electrode assembly shown in FIG. 9.

FIG. 12 illustrates a partially enlarged cross-sectional view of FIG. 11.

FIG. 13 illustrates a partial top plan view of a case corresponding to act S50 shown in FIG. 8.

### DETAILED DESCRIPTION

The present disclosure will be described more fully hereinafter with reference to the accompanying drawings, in which some embodiments are shown. As those skilled in the art would realize, the described embodiments may be modified in various different ways, all without departing from the spirit or scope of the present disclosure.

A pouch-type rechargeable battery may include an electrode assembly, a pouch-shaped case that accommodates and seals the electrode assembly and an electrolyte in an internal space, and a pair of strip terminals coupled to the electrode assembly and partially exposed to the outside of the case. The electrode assembly may be electrically connected to external devices by the pair of strip terminals.

The present disclosure relates to a strip terminal alignment device that may align a strip terminal at a designated position with respect to a case and a method of manufacturing a rechargeable battery using the same.

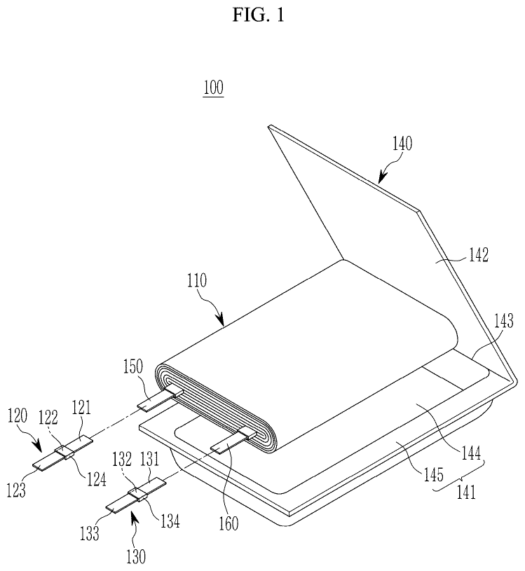

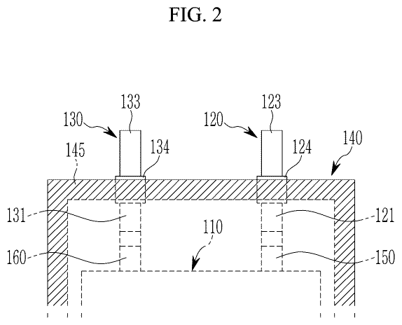

FIG. 1 illustrates an exploded perspective view of a typical pouch-type rechargeable battery. FIG. 2 illustrates a partially enlarged view of a typical pouch-type rechargeable battery. Before describing the strip terminal alignment device according to the present embodiments, a typical pouch-type rechargeable battery is briefly described.

Referring to FIG. 1 and FIG. 2, a typical rechargeable battery 100 may include an electrode assembly 110, first and second strip terminals 120 and 130 coupled to the electrode assembly 110, and a pouch-shaped case 140 accommodating and sealing the electrode assembly 110 and an electrolyte in an inner space thereof.

The electrode assembly 110 may include a first electrode, a second electrode, and a separator. The first electrode may be referred to as a positive electrode, and the second electrode may be referred to as a negative electrode. The separator may be disposed between the first electrode and the second electrode to insulate them. The electrode assembly 110 may be configured as a wound-type or a stacked-type.

In a wound-type electrode assembly, the first electrode, the second electrode, and the separator may have the shape of a long strip, and the first electrode and the second electrode may be stacked and wound with the separator interposed therebetween. In a stacked-type electrode assembly, each of the first electrode, the second electrode, and the separator may have a sheet shape, and a plurality of first electrodes and a plurality of second electrodes may be alternately stacked one by one with the separator interposed therebetween. In FIG. 1, a flat jelly roll-shaped wound-type electrode assembly 110 is illustrated as an example.

The first electrode may include a first electrode tab 150, and the second electrode may include a second electrode tab 160. The first electrode tab 150 and the second electrode tab 160 may be extended to the outside of the electrode assembly 110 and may be disposed at a distance from each other. The first strip terminal 120 may be fixed to the first electrode tab 150 by a method such as welding, and the second strip terminal 130 may be fixed to the second electrode tab 160 by a method such as welding.

The case 140 may include a first case 141 covering one side (e.g., a lower side in FIG. 1) of the electrode assembly 110 and a second case 142 covering the opposite side (e.g., an upper side in FIG. 1) of the electrode assembly 110. The first and second cases 141 and 142 may be integrally connected, and a folding line 143 may be disposed between the first case 141 and the second case 142. A concave portion 144 for accommodating the electrode assembly 110 may be disposed in the first case 141.

In a state in which the second case 142 is unfolded (or opened) with respect to the first case 141, the electrode assembly 110 may be accommodated in the concave portion 144, and the second case 142 may be folded to cover the electrode assembly 110. Three edges of the first and second cases 141 and 142 excluding the folding line 143 may be bonded to each other by thermal fusion to form a sealing portion 145.

The first and second strip terminals 120 and 130 may be configured of rigid metal rods. Inner portions 121 and 131 of the first and second strip terminals 120 and 130 may be fixed to the first electrode tab 150 or the second electrode tab 160, middle portions 122 and 132 thereof may overlap the sealing portion 145 of the case 140, and outer portions 123 and 133 thereof may be exposed to the outside of the case 140. The first and second strip terminals 120 and 130 can be outer terminals connected to an external device (not shown), and can electrically connect the electrode assembly 110 to the external device.

Since the sealing portion 145 of the case 140 has a weak adhesive strength with the metal, the insulating films 124 and 134 may surround the middle portions 122 and 132 of the first and second strip terminals 120 and 130 to increase the adhesive strength between the sealing portion 145 and the first and second strip terminals 120 and 130. In this case, the insulating films 124 and 134 may be made of a polymer resin having a lower melting point than the sealing portion 145 of the case 140.

The internal temperature and internal pressure of the rechargeable battery 100 may rapidly increase due to various causes such as rapid charging, external impact, and exposure to high temperature environments. In this case, the insulating films 124 and 134 are melted before the sealing portion 145 of the case 140 to emit the gas inside the case 140, thereby preventing rapid destruction of the rechargeable battery 100. That is, the insulating films 124 and 134 may serve as safety vents of the rechargeable battery 100.

According to some embodiments, the first and second strip terminals 120 and 130 must maintain their designated positions relative to the case 140 and be properly aligned without being inclined in the vertical direction or distorted in the left and right directions. When the first and second strip terminals 120 and 130 are out of the designated positions, poor connection with external devices may occur. When the first and second strip terminals 120 and 130 are inclined or twisted, the sealing portion 145 and the insulating films 124 and 134 may not be properly sealed and may form a gap, and when a conductor is introduced through the gap, a short circuit may occur.

The strip terminal alignment device of the present embodiments may be used to properly align the first and second strip terminals 120 and 130 at designated positions after the electrode assembly 110 to which the first and second strip terminals 120 and 130 are attached is accommodated in the concave portion 144 of the first case 141. After the strip terminal alignment device aligns the positions of the first and second strip terminals 120 and 130, the second case 142 may be folded, and the edges of the first and second cases 141 and 142 may be bonded to each other by thermal fusion.

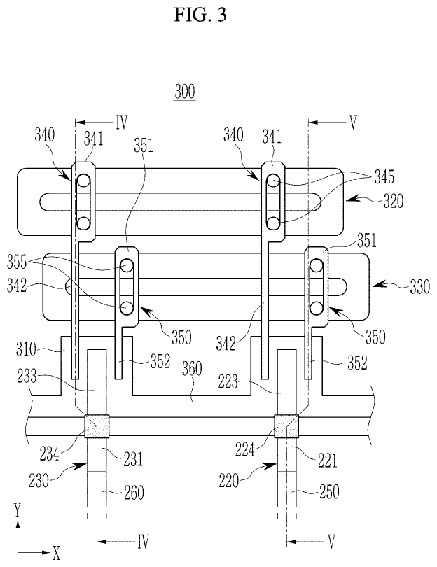

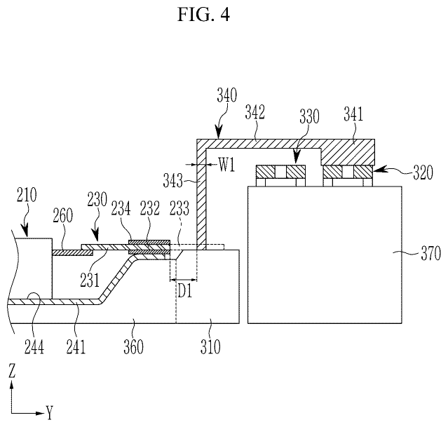

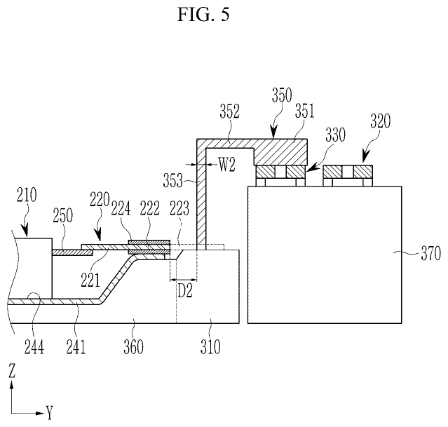

FIG. 3 illustrates a plan view of a strip terminal alignment device according to some embodiments. FIG. 4 and FIG. 5 illustrate cross-sectional views of the strip terminal alignment device taken along line IV-IV and line V-V of FIG. 3, respectively.

Referring to FIG. 1 to FIG. 5, the strip terminal alignment device 300 according to the present embodiments may include a terminal support 310 for supporting a pair of strip terminals 220 and 230, first and second jigs 320 and 330 disposed at a distance from the terminal support 310, a pair of first pushers 340 coupled to the first jig 320 at a distance from each other, and a pair of second pushers 350 coupled to the second jig 330 at a distance from each other.

The terminal support 310 may be disposed on one side of a case support 360. The case support 360 may support the first case 241 and the electrode assembly 210 accommodated in the first case 241, and may have a concave space corresponding to the concave portion 244 of the first case 241. The terminal support 310 may support the outer (side) portions 223 and 233 protruding to the outside of the first case 241 among the first and second strip terminals 220 and 230 fixed to the electrode assembly 210.

The width of the terminal support 310 in a first direction (X-axis direction) may be greater than the width of each of the first and second strip terminals 220 and 230. The protruding length of the terminal support 310 in a second direction (Y-axis direction) may be greater than the protruding length of the outer portions 223 and 233 of the first and second strip terminals 220 and 230, respectively. The first jig 320 and the second jig 330 may be disposed at a higher position than the terminal support 310 in a third direction (Z-axis direction). To this end, a jig support 370 may be provided under the first jig 320 and the second jig 330. The first and second jigs 320 and 330 may be disposed at a distance from the terminal support 310 along the second direction (Y-axis direction). The second jig 330 may be disposed between the terminal support 310 and first jig 320 along the second direction (Y-axis direction). The third direction (Z-axis direction) may be orthogonal to the first and second directions (X-axis direction and Y-axis direction).

With respect to the first and second strip terminals 220 and 230, the first direction (X-axis direction) may be parallel to the width direction of each of the first and second strip terminals 220 and 230, and the second direction (Y-axis direction) may be parallel to the length direction of each of the first and second strip terminals 220 and 230. In addition, the third direction (Z-axis direction) may be parallel to the thickness direction of each of the first and second strip terminals 220 and 230.

Each of the first jig 320 and the second jig 330 may have a shape of a long rod, and may be disposed parallel to the first direction (X-axis direction). The second jig 330 may be disposed closer to the terminal support 310 than the first jig 320. Each of the first jig 320 and the second jig 330 may be configured to be able to reciprocate in the first direction (X-axis direction). That is, each of the first jig 320 and the second jig 330 may slide from left to right or from right to left based on FIG. 3.

For reciprocating movement of the first jig 320 and the second jig 330, a driver (not shown) may be coupled to each of the first jig 320 and the second jig 330. The driver may be configured of a known electric motor, hydraulic actuator, or pneumatic actuator.

The pair of first pushers 340 may be fixedly installed on the first jig 320 at a distance from each other along the first direction (X-axis direction). One of the pair of first pushers 340 may push the first strip terminal 220 while in contact with one side of the first strip terminal 220 (the left side based on FIG. 3), and the other thereof may push the second strip terminal 230 while in contact with one side of the second strip terminal 230 (the left side based on FIG. 3).

Each of the pair of first pushers 340 may include a first fixing portion 341 fixedly installed on the first jig 320, a first horizontal extension 342 extending in a direction parallel to the second direction (Y-axis direction) from the first fixing portion 341 to approach the terminal support 310, and a first vertical extension 343 extending in a direction parallel to the third direction (Z-axis direction) from an end portion of the first horizontal extension 342 to approach the terminal support 310.

The first fixing portion 341 may be fixed to a specific position on the first jig 320, for example, by a pair of first bolts 345. The position of the first pusher 340 may be adjusted on the first jig 320 by loosening the first bolt 345, moving the first fixing portion 341, and then re-tightening the first bolt 345. The first horizontal extension 342 may cross the upper portion of the second jig 330 at a distance from the upper surface of the second jig 330. The first vertical extension 343 may be orthogonal to the first horizontal extension 342.

The width W1 (see e.g., width W1 in FIG. 4) of the first vertical extension 343 in the second direction (Y-axis direction) may be smaller than the lengths of the outer portions 223 and 233 of the first and second strip terminals 220 and 230 in the second direction (Y-axis direction), respectively. Accordingly, the first pusher 340 may contact only a portion of the side surfaces, not the entire side surface, of the outer portions 223 and 233. For example, the width W1 of the first vertical extension 343 in the second direction (Y-axis direction) may be equal to or less than half of the length of the outer portions 223 and 233 in the second direction (Y-axis direction).

In addition, the end portion of the first pusher 340 furthest from the first jig 320 may be disposed at a distance from the insulating films 224 and 234 along the second direction (Y-axis direction). In FIG. 4, the distance between the insulating film 234 and the first pusher 340 is indicated as D1.

The pair of second pushers 350 may be fixedly installed on the second jig 330 at a distance from each other along the first direction (X-axis direction). One of the pair of second pushers 350 may push the first strip terminal 220 while in contact with the other side of the first strip terminal 220 (the right side based on FIG. 3), and the other thereof may push the second strip terminal 230 while in contact with the other side of the second strip terminal 230 (the right side based on FIG. 3).

Each of the pair of second pushers 350 may include a second fixing portion 351 fixedly installed on the second jig 330, a second horizontal extension 352 extending in a direction parallel to the second direction (Y-axis direction) from the second fixing portion 351 to approach the terminal support 310, and a second vertical extension 353 extending in a direction parallel to the third direction (Z-axis direction) from an end portion of the second horizontal extension 352 to approach the terminal support 310. The pushers may push the strip terminals in a direction according to movement of the jig.

The second fixing portion 351 may be fixed to a specific position on the second jig 330, for example, by a pair of second bolts 355. The position of the second pusher 350 may be adjusted on the second jig 330 by loosening the second bolt 355, moving the second fixing portion 351, and then re-tightening the second bolt 355. The length of the second horizontal extension 352 in the second direction (Y-axis direction) may be smaller than the length of the first horizontal extension 342 in the second direction (Y-axis direction). The second vertical extension 353 may be orthogonal to the second horizontal extension 352.

The width W2 (see e.g., width W2 in FIG. 5) of the second vertical extension 353 in the second direction (Y-axis direction) may be smaller than the lengths of the outer portions 223 and 233 of the first and second strip terminals 220 and 230 in the second direction (Y-axis direction), respectively. Accordingly, the second pusher 350 may contact only a portion of the side surfaces, not the entire side surface, of the outer portions 223 and 233. For example, the width W2 of the second vertical extension 353 in the second direction (Y-axis direction) may be equal to or less than half of the length of the outer portions 223 and 233 in the second direction (Y-axis direction).

In addition, the end portion of the second pusher 350 furthest from the first jig 330 may be disposed at a distance from the insulating films 224 and 234 along the second direction (Y-axis direction). In FIG. 5, the distance between the insulating film 224 and the second pusher 350 is indicated as D2.

Since the strip alignment device 300 operates in a high-temperature environment for sealing (e.g., thermal fusion) of the case, the terminal support 310, the first jig 320, the second jig 330, the pair of first pushers 340, and the pair of second pushers 350 may be made of a heat-resistant metal without deformation at the sealing process temperature of the case (about 180° C. to 230° C.).

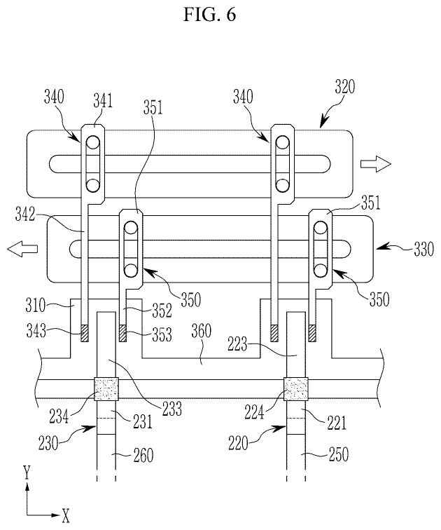

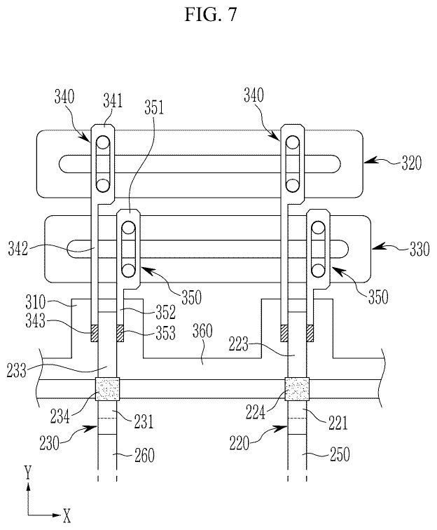

FIG. 6 and FIG. 7 are plan views of the strip terminal alignment device for describing an operation of the strip terminal alignment device, according to some embodiments.

Referring to FIG. 6, the first case 241 and the electrode assembly 210 may be disposed on the case support 360, and the first and second strip terminals 220 and 230 may be disposed on the terminal support 310. In this case, the distance between the first pusher 340 and the second pusher 350 in the first direction (X-axis direction) is greater than the width of each of the first and second strip terminals 220 and 230. Accordingly, the first and second strip terminals 220 and 230 may be easily disposed on the terminal support 310 without colliding with the first pusher 340 and the second pusher 350.

Referring to FIG. 7, the first jig 320 and the second jig 330 may slide in opposite directions to each other. For example, the first jig 320 may slide in a direction in which the pair of first pushers 340 face the first and second strip terminals 220 and 230, and the second jig 330 may slide in a direction in which the pair of second pushers 350 face the first and second strip terminals 220 and 230.

Referring to FIG. 7, the first jig 320 may slide to the right and the second jig 330 may slide to the left. Then, the pair of first pushers 340 may move to the right along the first jig 320 and contact the left side of each of the first and second strip terminals 220 and 230 to push the first and second strip terminals 220 and 230 to the right. The pair of second pushers 350 may move to the left along the second jig 330 and contact the right side of each of the first and second strip terminals 220 and 230 to push the first and second strip terminals 220 and 230 to the left. The pushers may be in contact with a portion of a side surface of the strip terminals at an end portion of a vertical extension.

The movement distances of the first jig 320 and the second jig 330 can be predetermined, and each of the first and second strip terminals 220 and 230 may be pushed toward a reference position by the first pusher 340 and the second pusher 350 and then stopped at the reference position. Thereafter, the second case (not shown) may be folded to overlap the first case 241 (see e.g., FIG. 4 and FIG. 5), and a sealing portion may be formed by thermal fusion.

Referring to FIG. 3 to FIG. 7, the strip terminal alignment device 300 may properly align the first and second strip terminals 220 and 230 to the reference positions through the above-described process. After the thermal fusion of the first case 241 and the second case, the first jig 320 slides to the left and the second jig 330 slides to the right, so that they may return to the initial position.

When the strip alignment device 300 is operated for a long time, the pair of first pushers 340 and the pair of second pushers 350 are heated by a high temperature environment. In addition, high temperatures of the first pusher 340 and the second pusher 350 may affect the insulating films 224 and 234. The insulating films 224 and 234 may include polypropylene (PP), and the melting point of the insulating films 224 and 234 may be about 140° C.

It may be assumed that the first jig and the second jig are disposed at the same height as the terminal support, and the pair of first pushers and the pair of second pushers extend in a direction parallel to the strip terminal to contact the entire side surface of the outer side of the strip terminal or most of the side surface of the outer side thereof. In this case, the high temperatures of the first and second pushers may affect the insulating film, causing the insulating film to overheat or melt. This phenomenon can cause shape deformation and functional deterioration of the insulating film, which may lead to safety deterioration of the rechargeable battery.

Referring back to FIG. 3 to FIG. 5, in the strip terminal alignment device 300 of the present embodiments, the remaining portions of the pair of first pushers 340 except for the lower end portion of the first vertical extension 343 may be disposed farther from (e.g., higher than) the insulating films 224 and 234. The remaining portions of the pair of second pushers 350 except for the lower end portion of the second vertical extension 353 may be disposed farther from (e.g., higher than) the insulating films 224 and 234. The end portion of the first vertical extension 343 may face one side of the first and second strip terminals 220 and 230, and the end portion of the second vertical extension 353 may face another side of the first and second strip terminals 220 and 230. The end portion of the first vertical extension 343 and the second vertical extension 353 may be disposed at a distance from the insulating films 224 and 234 along the second direction (Y-axis direction).

In addition, each of the pair of first pushers 340 and the pair of second pushers 350 may be disposed at the distances D1 and D2 from the insulating films 224 and 234 along the second direction (Y-axis direction). By the configuration of the first pusher 340 and the second pusher 350 described above, most of the first pusher 340 and the second pusher 350 that maintain high temperature may be disposed far from the insulating film 224 and 234, so that the thermal effect on the insulating films 224 and 234 may be minimized.

In this case, the separation distances D1 and D2 between the insulating films 224 and 234 in the second direction (Y-axis direction) and each of the first and second pushers 340 and 350 (e.g., an end portion of the vertical extension) may be approximately 0.3 times or more and 0.7 times or less of the length of the outer portions 223 and 233 in the second direction (Y-axis direction).

When the separation distances D1 and D2 between the insulating films 224 and 234 and the first and second pushers 340 and 350 are less than 0.3 times the length of the outer portions 223 and 233, the high-temperature first and second pushers 340 and 350 may thermally affect the insulating films 224 and 234, causing overheating of the insulating films 224 and 234.

When the separation distances D1 and D2 between the insulating films 224 and 234 and the first and second pushers 340 and 350 exceed 0.7 times the length of the outer portions 223 and 233, during the process in which the first and second pushers 340 and 350 push the first and second strip terminals 220 and 230, a phenomenon in which the first and second strip terminals 220 230 are not aligned with the second direction (Y-axis direction) and are misaligned may occur.

The strip terminal alignment device 300 of the present embodiments may minimize the thermal effect on the insulating films 224 and 234 in the process of aligning the first and second strip terminals 220 and 230 using the pair of first pushers 340 and the pair of second pushers 350. As a result, the shape deformation and functional deterioration of the insulating films 224 and 234 may be suppressed, and the safety of the rechargeable battery may be improved.

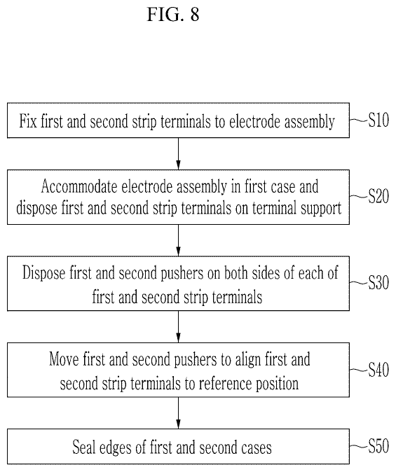

Next, a method of manufacturing a rechargeable battery using the strip terminal alignment device 300 described above will be described. FIG. 8 illustrates a process flowchart of a method of manufacturing a rechargeable battery according to some embodiments.

Referring to FIG. 8, the method for manufacturing the rechargeable battery according to the present embodiments may include fixing first and second strip terminals to an electrode assembly (act S10), accommodating the electrode assembly in a first case and disposing the first and second strip terminals on a terminal support (act S20), disposing a pair of first pushers on one side of the first and second strip terminals and disposing a pair of second pushers on the other side of the first and second strip terminals (act S30), moving the pair of first pushers and the pair of second pushers to align the first and second strip terminals to a reference position (act S40), and disposing a second case on the electrode assembly and then sealing edges of the first and second cases (act S50).

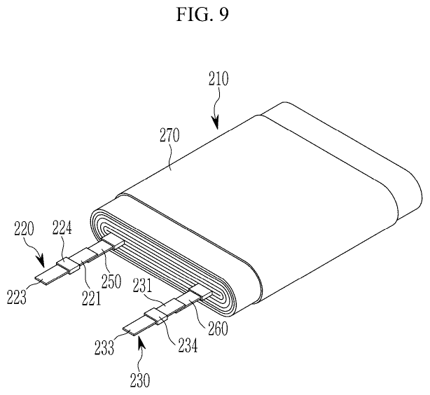

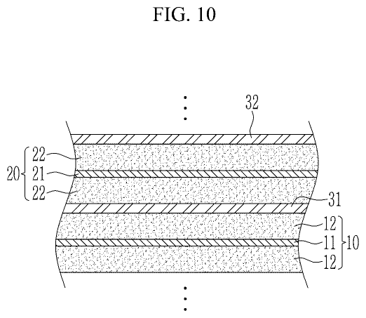

FIG. 9 illustrates a perspective view of an electrode assembly and first and second strip terminals corresponding to act S10 shown in FIG. 8. FIG. 10 illustrates a partially enlarged cross-sectional view of the electrode assembly shown in FIG. 9.

Referring to FIG. 9 and FIG. 10, in act S10, the electrode assembly 210 may be configured as a stack including a first electrode 10, a first separator 31, a second electrode 20, and a second separator 32 wound multiple times. Each of the first electrode 10, the first separator 31, the second electrode 20, and the second separator 32 may have a shape of a long strip, and the stack may be wound in the shape of a flat jelly roll.

The edge of the stack may be covered with a finishing tape 270. The first electrode 10 may be referred to as a positive electrode, and the second electrode 20 may be referred to as a negative electrode.

The positive electrode may include a positive substrate 11 and a positive active material layer 12 disposed on at least one surface of the positive substrate 11. The positive substrate 11 may be referred to as a positive current collector. The positive substrate 11 may be made of aluminum or the like, and may be configured in the form of a thin plate or a foam. The positive active material layer 12 includes a positive active material, and may optionally further include a binder and/or a conductive material.

The positive active material may include a lithium transition metal composite oxide. The lithium transition metal composite oxide may include, for example, at least one of a lithium-nickel-based oxide, a lithium-cobalt-based oxide, a lithium-manganese-based oxide, a lithium-iron phosphate-based compound, and a cobalt-free lithium nickel-manganese-based oxide.

The negative electrode may include a negative substrate 21 and a negative active material layer 22 disposed on at least one surface of the negative substrate 21. The negative substrate 21 may be referred to as a negative current collector. The negative substrate 21 may be made of copper, nickel, a copper alloy, a nickel alloy, or the like, and may be configured in the form of a thin plate or a foam. The negative active material layer 22 includes a negative active material, and may further include selectively a binder and/or a conductive material.

The negative active material may include at least one of a carbon-based active material and a silicon-based active material. The carbon-based active material may include at least one of natural graphite and artificial graphite. The silicon-based active material may include at least one of a silicon-carbon composite active material and a silicon oxide (SiOx, 0<x≤2).

In each of the positive active material layer 12 and the negative active material layer 22, the binder may include at least one of an aqueous binder, a non-aqueous binder, and a dry binder. In each of the positive active material layer 12 and the negative active material layer 22, the conductive material may include at least one of a carbon-based material such as natural graphite, artificial graphite, carbon black, carbon fiber, carbon nanofiber, carbon nanotube, metal powder including copper, nickel, aluminum, silver, and the like, or a metal material in the form of a metal fiber, and a conductive polymer such as a polyphenylene derivative.

The first and second separators 31 and 32 may be configured of a porous substrate or a porous substrate having a coating layer disposed on at least one surface thereof. The porous substrate may include one or more of polyethylene, polypropylene, polyethylene terephthalate, polypropylene terephthalate, polybutylene terephthalate, polyester, polycarbonate, and polyimide. The coating layer may include a binder, and the binder may include a polyvinylidene fluoride-based compound. The first and second separators 31 and 32 may insulate the positive electrode and the negative electrode while allowing lithium ions to move.

The electrode assembly 210 may include a first electrode tab 250 and a second electrode tab 260. The first electrode tab 250 may be a positive electrode tab attached to the positive substrate 11 or extending from the positive substrate 11. The second electrode tab 260 may be a negative electrode tab attached to the negative electrode substrate 21 or extending from the negative electrode substrate 21. The first electrode tab 250 and the second electrode tab 260 may be disposed at a distance from each other, and may extend to the outside of the electrode assembly 210.

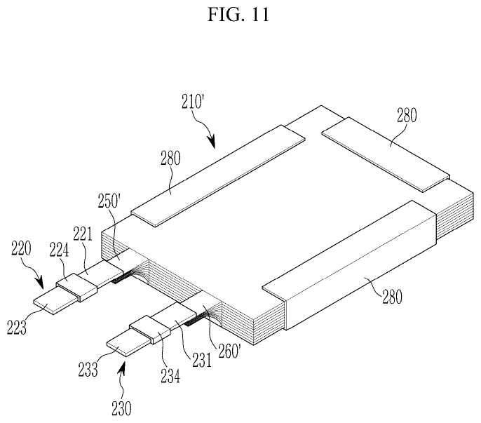

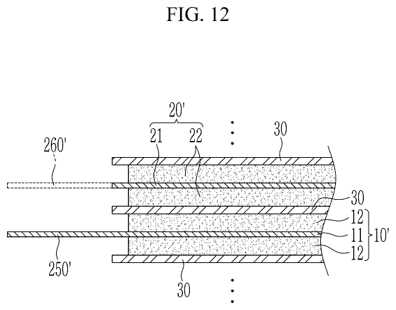

FIG. 11 illustrates a perspective view of a modified example of the electrode assembly shown in FIG. 9. FIG. 12 illustrates a partially enlarged cross-sectional view of FIG. 11.

Referring to FIG. 11 and FIG. 12, in act S10, an electrode assembly 210′ may be configured with a plurality of first electrodes 10′ and a plurality of second electrodes 20′ alternately stacked one by one with a separator 30 therebetween. Each of the plurality of first electrodes 10′, the plurality of second electrodes 20′, and the plurality of separators 30 may have a quadrangular sheet shape. The electrode assembly 210′ may maintain its shape without distortion by a plurality of finishing tapes 280 attached to the edge thereof.

The first electrode 10′ may be referred to as a positive electrode, and the second electrode 20′ may be referred to as a negative electrode. The detailed configurations of the positive electrode and the negative electrode are the same as those described with reference to FIG. 9 and FIG. 10, so redundant descriptions will be omitted.

The electrode assembly 210′ may include a plurality of first electrode tabs 250′ and a plurality of second electrode tabs 260′. The plurality of first electrode tabs 250′ may be positive electrode tabs extended from each of the plurality of positive substrates 11 and may be integrally fixed by a method such as welding. The plurality of second electrode tabs 260′ may be negative electrode tabs extended from each of the plurality of negative electrode substrates 21 and may be integrally fixed by a method such as welding.

Referring back to FIG. 9, the first and second strip terminals 220 and 230 may be formed of a solid metal rod, and may be fixed to the first and second electrode tabs 250 and 260, respectively, by a method such as welding. The first and second strip terminals 220 and 230 may be divided into inner portions 221 and 231, middle portions 222 and 232 (see e.g., FIG. 4 and FIG. 5), and outer portions 223 and 233, respectively.

The inner portions 221 and 231 may be fixed to the first electrode tab 250 or the second electrode tab 260, and may be disposed inside the case after the case is sealed. The middle portions 222 and 232 (see e.g., FIG. 4 and FIG. 5) overlap the sealing portion of the case, and are surrounded by the insulating films 224 and 234. The outer portions 223 and 233 are exposed to the outside (an outside area) of the case after the case is sealed. The insulating films 224 and 234 may include a polymer resin such as polypropylene (PP), and the melting point of the insulating films 224 and 234 may be about 140° C.

Referring back to FIG. 3 to FIG. 5, in act S20, the first case 241 may be disposed on the case support 360, and the electrode assembly 210 may be accommodated in the concave portion 244 of the first case 241. In addition, the first and second strip terminals 220 and 230 may be disposed on the terminal support 310.

In this case, the second case (not shown) may be integrally connected to the first case 241 with a folding line (not shown) interposed therebetween, and may maintain an unfolded (or open) state with respect to the first case 241. The configuration of the case may be the same as that of the case 140 of FIG. 1.

Each of the first case 241 and the second case (not shown) may have a multi-layered structure of a metal sheet and a polymer sheet. The metal sheet may be an aluminum sheet and may provide mechanical strength to the case. The polymer sheet may be configured of a polyethylene terephthalate (PET) sheet, a nylon sheet, a PET-nylon composite sheet, or the like, and may provide insulation and protection functions to the case. The metal sheet may be disposed between at least two polymer sheets.

In act S30, the pair of first pushers 340 may be disposed on one side (left side based on FIG. 3) of the first and second strip terminals 220 and 230, and the pair of second pushers 350 may be disposed on the opposite side (right side based on FIG. 3) of the first and second strip terminals 220 and 230.

Referring to FIG. 6, in acts S20 and S30, the distance between the first pusher 340 and the second pusher 350 in the first direction (X-axis direction) is greater than the width of each of the first and second strip terminals 220 and 230 in the first direction (X-axis direction). Accordingly, in acts S20 and S30, the first and second strip terminals 220 and 230 may be easily disposed on the terminal support 310 without colliding with the first and second pushers 340 and 350.

Referring to FIG. 7, in act S40, the first jig 320 and the second jig 330 may slide in opposite directions to each other. For example, referring to FIG. 7, the first jig 320 may slide to the right and the second jig 330 may slide to the left.

The pair of first pushers 340 may push each of the first and second strip terminals 220 and 230 to the right while moving to the right by the first jig 320. The pair of second pushers 350 may push each of the first and second strip terminals 220 and 230 to the left while moving to the left by the second jig 330. The first and second strip terminals 220 and 230, respectively, may be pushed toward the reference position by the first pusher 340 and the second pusher 350 and then stopped at the reference position.

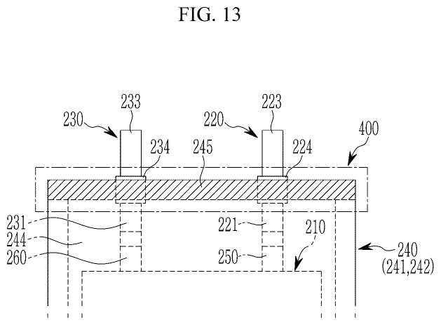

FIG. 13 illustrates a partial top plan view of a case corresponding to act S50 shown in FIG. 8.

Referring to FIG. 13, in act S50, the second case 242 may be disposed on the first case 241 and the electrode assembly 210. For example, the second case 242 may be folded based on a folding line to cover the first case 241 and the electrode assembly 210. Subsequently, a high-temperature sealing device 400 may press the edge of the second case 242 from top to bottom to thermally fuse the edges of the first and second cases 241 and 242.

The edges of the first and second cases 241 and 242 may be integrally bonded by thermal fusion by the sealing device 400 to form a sealing portion 245. Thermal fusion may also be performed on the remaining edges of the first and second cases 241 and 242 to form a sealing portion. Thereafter, the first and second strip terminals 220 and 230 may be connected to a circuit module (not shown), and may be connected to an external device (not shown) to electrically connect the electrode assembly 210 to the external device.

In the rechargeable battery manufactured by the above-described process, the insulating films 224 and 234 of the first and second strip terminals 220 and 230 overlap the sealing portion 245 of the case 240. The insulating films 224 and 234 can increase the adhesive force between the case 240 and the first and second strip terminals 220 and 230, and can function as a safety vent of the rechargeable battery.

That is, in the process of using the rechargeable battery, in cases when the internal temperature and internal pressure of the case 240 rapidly increase due to various causes such as rapid charging, external impact, and exposure to a high-temperature environment, the insulating films 224 and 234 melt earlier than the sealing part 245 to discharge the gas inside the case 240, thereby preventing rapid destruction of the rechargeable battery.

In acts S20 to S50, the strip terminal alignment device is disposed close to the sealing device, so it maintains a high temperature due to the high heat of the sealing device. In acts S30 and S40, the pair of first pushers have the first vertical extension, and the pair of second pushers have the second vertical extension, thereby minimizing an area in contact with the first and second strip terminals and reducing the thermal effect on the insulating film.

In addition, since each of the pair of first pushers and the pair of second pushers maintains a separation distance from the insulating film along the second direction, the thermal effect on the insulating film may be minimized. The separation distance between the insulating film and each of the first and second pushers along the second direction may be approximately 0.3 times or more and 0.7 times or less of the length of the outer portion along the second direction. According to the method of manufacturing the rechargeable battery described above, the safety of the rechargeable battery may be improved by suppressing the shape deformation and function deterioration of the insulating film.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the disclosure.

What is claimed is:

1. A strip terminal alignment device comprising:
a terminal support supporting a first strip terminal and a second strip terminal;
a first jig and a second jig configured to be able to be reciprocally moved along a first direction and disposed at a distance from the terminal support along a second direction;
a pair of first pushers fixed to the first jig at a distance from each other and configured to push one side of each of the first and second strip terminals in one direction according to movement of the first jig; and
a pair of second pushers fixed to the second jig at a distance from each other and configured to push another side of each of the first and second strip terminals in a direction opposite the one direction according to movement of the second jig,
wherein each of the pair of first pushers and the pair of second pushers includes a vertical extension parallel to a third direction orthogonal to the first direction and the second direction.

2. The strip terminal aligning device of claim 1, wherein:
each of the first and second jigs is disposed higher than the terminal support along the third direction, and
the second jig is disposed between the terminal support and the first jig along the second direction.

3. The strip terminal aligning device of claim 2, wherein:
each of the pair of first pushers includes a first fixing portion fixed to the first jig, a first horizontal extension connected to the first fixing portion and parallel to the second direction, and a first vertical extension connected to the first horizontal extension and parallel to the third direction, and
an end portion of the first vertical extension faces one side of each of the first and second strip terminals.

4. The strip terminal aligning device of claim 3, wherein:
the first horizontal extension crosses an upper portion of the second jig at a distance from the upper surface of the second jig.

5. The strip terminal aligning device of claim 3, wherein:
each of the first and second strip terminals includes an inner portion fixed to an electrode assembly, a middle portion surrounded by an insulating film, and an outer portion exposed to an outside area of the case, and
a width of the first vertical extension along the second direction is smaller than a length of the outer portion along the second direction.

6. The strip terminal aligning device of claim 5, wherein:
the width of the first vertical extension along the second direction is equal to or less than half the length of the outer portion along the second direction, and
an end portion of the first vertical extension is disposed at a distance from the insulating film along the second direction.

7. The strip terminal aligning device of claim 6, wherein:
a distance between the end portion of the first vertical extension and the insulating film is 0.3 times or more and 0.7 times or less of the length of the outer portion along the second direction.

8. The strip terminal aligning device of claim 2, wherein:
each of the pair of second pushers includes a second fixing portion fixed to the second jig, a second horizontal extension connected to the second fixing portion and parallel to the second direction, and a second vertical extension connected to the second horizontal extension and parallel to the third direction, and
an end portion of the second vertical extension faces the another side of each of the first and second strip terminals.

9. The strip terminal aligning device of claim 8, wherein:
each of the first and second strip terminals includes an inner portion fixed to an electrode assembly, a middle portion surrounded by an insulating film, and an outer portion exposed to an outside area of the case, and
a width of the second vertical extension along the second direction is smaller than a length of the outer portion along the second direction.

10. The strip terminal aligning device of claim 9, wherein:
the width of the second vertical extension along the second direction is equal to or less than half the length of the outer portion along the second direction, and
an end portion of the second vertical extension is disposed at a distance from the insulating film along the second direction.

11. The strip terminal aligning device of claim 10, wherein:
a distance between the end portion of the second vertical extension and the insulating film is 0.3 times or more and 0.7 times or less of the length of the outer portion along the second direction.

12. The strip terminal aligning device of claim 1, wherein:
the pair of first pushers and the pair of second pushers move in opposite directions to contact side surfaces of the first and second strip terminals, respectively, to align the first and second strip terminals at a reference position, respectively.

13. A method of manufacturing a rechargeable battery, comprising:
fixing first and second strip terminals to an electrode assembly;
accommodating the electrode assembly in a first case and disposing the first and second strip terminals on a terminal support;
disposing a pair of first pushers on one side of each of the first and second strip terminals and disposing a pair of second pushers on another side of each of the first and second strip terminals;
moving the pair of first pushers and the pair of second pushers in opposite directions to respectively align the first and second strip terminals to a reference position; and
disposing a second case on the electrode assembly and sealing edges of the first case and the second case,
wherein each of the pair of first pushers and the pair of second pushers includes a vertical extension parallel to a thickness direction of the first and second strip terminals and is in contact with a portion of a side surface of each of the first and second strip terminals at an end portion of the vertical extension.

14. The method of manufacturing the rechargeable battery of claim 13, wherein:
each of the first and second strip terminals includes an inner portion fixed to the electrode assembly, a middle portion surrounded by an insulating film, and an outer portion disposed on the terminal support, and
after sealing the first and second cases, the insulating film overlaps sealing portions of the first and second cases.

15. The method of manufacturing the rechargeable battery of claim 14, wherein:
each of the pair of first pushers includes a first vertical extension,
a width of the first vertical extension along a length direction of the first and second strip terminals is smaller than a length of the outer portion, and
an end portion of the first vertical extension is disposed at a distance from the insulating film.

16. The method of manufacturing the rechargeable battery of claim 15, wherein:
the width of the first vertical extension is less than half the length of the outer portion, and
a distance between the insulating film and the first vertical extension is 0.3 times or more and 0.7 times or less of the length of the outer portion.

17. The method of manufacturing the rechargeable battery of claim 14, wherein:
each of the pair of second pushers includes a second vertical extension,
a width of the second vertical extension along a length direction of the first and second strip terminals is smaller than a length of the outer portion, and
an end portion of the second vertical extension is disposed at a distance from the insulating film.

18. The method of manufacturing the rechargeable battery of claim 17, wherein:
the width of the second vertical extension is less than half the length of the outer portion, and
a distance between the insulating film and the second vertical extension is 0.3 times or more and 0.7 times or less of the length of the outer portion.
